(19) United States
(12) Patent Application Publication
(10) Pub. No.: US 2017/0180470 A1
(43) Pub. Date: Jun. 22, 2017

(54) Method and electronic device for sending CDN address

(71) Applicants: Le Holdings (Beijing) Co., Ltd., Beijing (CN); LeCloud Computing Co., Ltd., Beijing (CN)

(72) Inventor: Hai ZHANG, Beijing (CN)

(21) Appl. No.: 15/246,542

(22) Filed: Aug. 25, 2016

Related U.S. Application Data
(63) Continuation of application No. PCT/CN2016/089468, filed on Jul. 8, 2016.

(30) Foreign Application Priority Data
Dec. 21, 2015 (CN) 201510969742.X

(51) Int. Cl. H04L 29/08

(52) U.S. Cl. CPC H04L 67/1074; H04L 67/18; H04L 67/1063

(57) ABSTRACT

Disclosed are a method and an electronic device for sending a CDN address. The method includes: establishing P2P connections with other terminal nodes in a network; obtaining server information stored in each of the other terminal nodes, wherein the server information stored in each terminal node includes an IP address of a CDN server which is connected to the terminal node by default; recording the obtained server information and server information of a CDN server which is connected to itself by default into a server list; searching server information which meets a preset condition from the server list; and making a request for downloading data to a CDN server corresponding to the found server information.

### CROSS REFERENCE TO RELATED APPLICATIONS

This application is a continuation of International Application No. PCT/CN2016/089468, filed on Jul. 8, 2016, which is based upon and claims priority to Chinese Patent Application No. 201510969742.X, filed on Dec. 21, 2015, the entire contents of all of which are incorporated herein by reference.

### TECHNICAL FIELD

The present disclosure relates to telecommunication technologies, and more particularly, to a method and an electronic device for sending a CDN address.

### BACKGROUND

Content Delivery Network (CDN) is a new network content service system, which distributes contents and provides services based on efficiency and quality requirements of content access and applications, and content organizations. The CDN technology tries to avoid any bottlenecks and nodes across the Internet that may influence data transmission speed and stability so as to realize more quickly and reliable content transmission. By deploying CDN servers at various locations across networks to form a layer of intelligent virtual network on the basis of existing Internet, the CDN system can redirect a user's request to a service node closest to the user by taking a combination of real-time factors into account, for example, network traffic, connections and load conditions of each node, the distance to the user, response time, and so on. The CDN system enables users to obtain desired contents from geographically nearby nodes and thereby response speed for users to access websites can be increased.

When data needs to be downloaded from a terminal node, a data obtaining request is sent to a scheduling server. The obtaining request contains the address information of the terminal node. According to the address information of the terminal node, the scheduling server sends to the terminal node a CDN address corresponding to the address information of the terminal node, and then the address of the server from which the data can be downloaded is determined.

In prior arts, the address of an optimal download server from which the data can be downloaded can be selected. However, if the currently selected download server is abnormal, the download may fail. If the download fails, the terminal node needs to request to download data again, and the same download server may be selected again according to the address information, and download of data is carried out for another time. Since the same download server is selected to download data, if it is the network that i s abnormal, the terminal node can download data successfully; if it is the download server that is abnormal, the terminal node cannot download data successfully. Such selection of CDN address cannot ensure successful data download when the download server is abnormal.

### SUMMARY

The present disclosure provides a method and an electronic device for sending a CDN address to solve the problem of incapability of ensuring successful data download when a download server is abnormal.

In order to solve the above technical problem, according to a first aspect, embodiments of the present disclosure provide a method for sending a CDN address, implemented by a terminal node, including:

establishing peer-to-peer (P2P) connections with other terminal nodes in a network;

obtaining server information stored in each of the other terminal nodes, wherein the server information stored in each terminal node includes an internetworking protocol (IP) address of a CDN server which is connected to the terminal node by default;

recording the obtained server information and server information of a CDN server which is connected to itself by default into a server list;

searching server information which meets a preset condition from the server list; and

making a request for downloading data to a CDN server corresponding to the found server information.

In a second aspect, embodiments of the present disclosure provide a non-transitory computer-readable storage medium storing executable instructions, wherein the executable instructions are configured to perform any methods for sending a CDN address mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for sending a CDN address mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for sending a CDN address in accordance with some embodiments.

FIG. 2 is a flow chart of another method for sending a CDN address in accordance with some embodiments.

FIG. 3 is a block diagram of a device for sending a CDN address in accordance with some embodiments.

FIG. 4 is a block diagram of another device for sending a CDN address in accordance with some embodiments.

FIG. 5 is a block diagram of a structure of a device for sending a CDN address in accordance with some embodiments.

FIG. 6 is a block diagram of an electronic device which is configured to perform the methods for sending a CDN address in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

In order to ensure that even a download server is abnormal data can be downloaded successfully, embodiments of the present disclosure provide a method for sending a CDN address. As shown in FIG. 1, the method can include the following steps.

In 101, P2P connections with other terminal nodes in a network are established.

The terminology “network” in embodiments of the present disclosure refers to a network in the computer field, which may be a virtual platform for sending, receiving and sharing of information and by which information at each point, facet, or body is interrelated to realize sharing of resources. A terminal node in a network refers to a terminal computer or other device accessing the network.

The terminology “P2P” means that computers across a network have equivalent functions, i.e., there is no master or slave computer—one computer, which is a terminal computer, can also serve as a server which share resources with other computers in the network.

By establishing the P2P connections with other terminal nodes in the network, the terminal nodes in the network play both roles of independent terminals and resource obtainers which obtain resources shared by other terminal nodes. The number of the terminal nodes connected in the P2P manner may be smaller than a threshold value which can be set based on restriction conditions. However, embodiments of the present disclosure do not impose specific limitations on the number of the terminal nodes.

In 102, server information stored in each of the other terminal nodes is obtained.

The server information stored in each terminal node is configured to record an IP address of a CDN server which is connected to the terminal node by default. Each of the terminal nodes stores the information of the server which is connected to the terminal node by default. By obtaining the server information stored in the other terminal nodes from the other terminal nodes, sharing of the service information is realized. The number of the other terminal nodes can correspond to the number of the pieces of the obtained service information.

The obtaining of the server information can be performed when there is a data download request, or may be carried out every time interval. Embodiments of the present disclosure do not impose specific limitations on the time for obtaining the service information.

In 103, the obtained server information and server information of a CDN server which is connected to itself by default are recorded into a server list.

Each terminal node has a CDN server which is connected to the terminal node by default. The information of the CDN server which is connected to the terminal node by default and the service information of the other terminal nodes obtained in step 102 are recorded in a server list. All of the servers in the server list are those which terminals can be directly connected to.

In 104, server information which meets a preset condition is searched from the server list.

Servers provide data transmission services for terminal nodes. If a server meets a preset condition, it means that the server can meet the requirements of data transmission with terminal nodes. From the server list, such server information which meets the data transmission requirements of the terminal node can be searched.

In 105, a request for downloading data is made to a CDN server corresponding to the found server information.

After the server information which meets the preset condition is found in step 104, a request can be sent to a CDN server corresponding to the found server information so as to request to download data.

In the method for sending a CDN address provided by embodiments of the present disclosure, P2P connections are established with other terminal nodes in a network, server information stored in each of the other terminal nodes is obtained, the server information is recorded in a server list, server information which meets a preset condition is found from the server list, and a request for downloading data is made to a CDN server corresponding to the found server information which meets the preset condition. As compared with prior arts, embodiments of the present disclosure can find information of a server which is not abnormal and request to download data to the server which is not abnormal. Thus, embodiments of the present disclosure can ensure that even the download server is abnormal, data can be downloaded successfully.

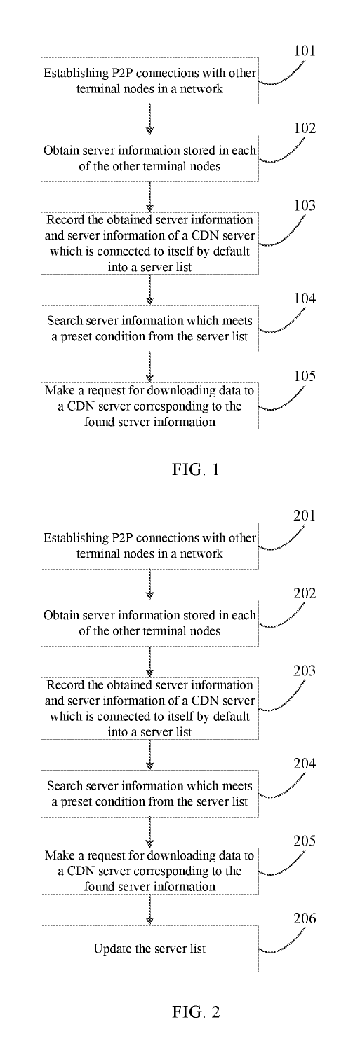

Embodiments of the present disclosure provide another method for sending a CDN address to give more details of the method described in connection with FIG. 1. As shown in FIG. 2, the method can include the following steps.

In 201, P2P connections with other terminal nodes in a network are established.

The step can be implemented as the step 101 in the method of FIG. 1, and repeated descriptions are omitted here.

In 202, server information stored in each of the other terminal nodes is obtained.

The server information stored in each terminal node is configured to record an IP address of a CDN server which is connected to the terminal node by default. The server information is further configured to record a location of the CDN server which is connected to the terminal node by default and a download speed of the CDN server. By containing the location information and download speed of the CDN server in addition to the IP address of the CDN server in the server information, the information and status of the CDN server can be reflected accurately.

For obtaining server information stored in each of the other terminal nodes, inquiry information can be sent to each of the other terminal nodes. The inquiry information sent to each other terminal node is configured to inquire the server information of the CDN server connected to the other terminal node. Then, the server information returned by each of the other terminal nodes can be received.

By inquiring and receiving, the server information returned by other terminal nodes can be received, which indicates that the terminals that return the server information are working. This can ensure that the serer information received from the other terminal nodes are the information of the servers which are working currently.

The sending of the inquiry information can be carried out when there is a data download request, or can be carried out every time interval. Embodiments of the present disclosure do not impose specific limitations on the time for sending inquiry information.

When a terminal nodes needs to obtain server information, it can sends inquiry information, instead of sending the server information by the other terminal nodes at a fixed time interval. That is, only the desired information is transmitted across the internet, and thus network resources can be saved.

In 203, the obtained server information and server information of a CDN server which is connected to itself by default are recorded into a server list.

The server information returned by each terminal node also contains the location of the CDN server connected to the terminal node by default and the download speed of the CDN server. That is, each piece of the server information in the server list should give out not only the basic information of each server but also download effect which can be realized if the server is used.

An index value can be used to reflect the download effect. The higher the index value is, the faster the download speed will be. For example, distances between a location of itself and locations of individual CDN servers can be calculate, index values of individual CDN servers can be calculated according to the calculated distances and the download speeds of the CDN servers, and each piece of server information can be recorded in the server list orderly according to the index values.

The distance from a terminal to a CDN server and the download speed of the CDN server are two factors which may influence the data download speed of the terminal. The far the distance from the terminal to the CDN server is, the slower the data download speed will be. The download speed of a CDN server is related to the resources of the CDN server itself. A slow download speed indicates that the remaining resources of the CDN server are limited. Different weights can be applied into the distance from the terminal to the CDN server and the download speed of the CDN server to calculate the index value of the CDN server. Embodiments of the present disclosure do not impose specific limitations on the weighting. The pieces of server information can be recorded in the server list orderly according to the index values.

In 204, server information which meets a preset condition can be searched from the server list.

A terminal node can be connected to a default CDN server firstly. If the default CDN server is abnormal and data cannot be downloaded, server information which meets a preset condition can be searched from the server list. For example, a preset number of pieces of server information can be found in a descending order of the index values.

The abnormality occurring in a CDN server may refer to timeout of download, over slow download speed, or a 404 error which indicates that the server cannot provide information normally. The time limits for determining timeout of download, and the speed restrictions for determining an over slow download speed are recorded in the terminal node. However, embodiments of the present disclosure do not specify the limits for determining timeout of download, and the speed restrictions for determining an over slow download speed. The restriction conditions can be preset in the terminal node, or can be manually set or changed by users, or can be determined according to the data to be downloaded by users. Embodiments of the present disclosure do not impose specific limitations on the setting manner of the restriction conditions.

There may be more than one pieces of server information that meets the preset condition. Embodiments of the present disclosure do not impose specific limitations on the number of the pieces of server information which meets the preset condition. If more CDN servers can be found, the data can be downloaded more quickly. However, the download speeds of the CDN servers are different, and thus setting a limit for the number of the found servers is necessary to ensure the download speeds of the found CDN servers.

In 205, a request for downloading data is made to a CDN server corresponding to the found server information.

The information found in step 204 may be regarding one or more than one CDN server. If the found server information is regarding one CDN server, the request for downloading data is directly sent to the found CDN server.

If a plurality of CDN servers are found, the request can be made to the plurality of CDN servers for downloading data. A limit may be set for the number of the plurality of CDN servers from which the request for downloading data can be made to. The limit for the number can be a fixed value, or can vary depending on users' requests, or can be manually set by users. Embodiments of the present disclosure do not define the magnitude and setting manner of the limit for the number.

When the request for downloading data is made to at least two CDN servers, a data segment which needs to be downloaded from each of the CDN servers is determined, and the request is made to the at least two CDN servers for downloading the data segment corresponding to each CDN server. In order to avoid repeated sending of download requests to servers and increase data download speed, requests can be made to a plurality of CDN server concurrently for downloading data. The data to be downloaded can be divided into a plurality of data segments, and a data segment which is to be downloaded from each CDN server can be determined. Embodiments of the present disclosure do not impose specific limitations on the segmentation of the data to be downloaded. For example, data can be divided into a plurality of segments, and the segments can be assigned evenly for each CDN server, or can be assigned according to index values of the CDN values. Embodiments of the present disclosure do not impose specific limitations on the assignment or determination of the data segment which is to be downloaded from each CDN server.

In 206, the server list is updated.

Specifically, the server information stored in each of the other terminal nodes is obtained at preset time intervals, and the server list is updated according to the server information. Other terminal nodes which a terminal is connected to may change over time, and the download speeds of the CDN servers which are connected to the other terminal nodes by default may change. Thus, the server list needs to be updated to select a more optimal CDN server when the CDN server for downloading data is abnormal.

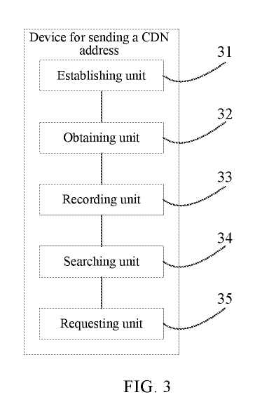

Further, embodiments of the present disclosure provide a device for sending a CDN address to implement the above methods described in connection with FIGS. 1 and 2. The embodiments of the device correspond to the above embodiments of the methods, and for the purpose of easy reading, details in the above embodiments of methods which can apply to the embodiments of the device are not described here. However, it should be understood that the embodiments of the device can implement all the steps in the above methods of methods. As shown in FIG. 3, the device can include an establishing unit 31, an obtaining unit 32, a recording unit 33, a searching unit 34 and a requesting unit 35.

The establishing unit 31 is configured to establish P2P connections with other terminal nodes in a network.

The obtaining unit 32 is configured to obtain server information stored in each of the other terminal nodes with which connections are established by the establishing unit 31. The server information stored in each terminal node includes an IP address of a CDN server which is connected to the terminal node by default.

The recording unit 33 is configured to record the server information obtained by the obtaining unit 32 and server information of a CDN server which is connected to itself by default into a server list.

The searching unit 34 is configured to search server information which meets a preset condition from the server list which is recorded by the recording unit 33.

The requesting unit 35 is configured to make a request for downloading data to a CDN server corresponding to the server information found by the searching unit 34.

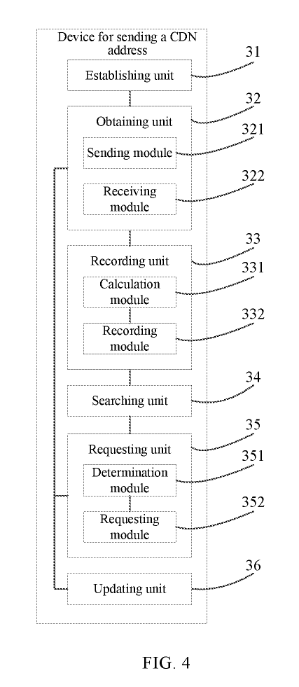

Further, as shown in FIG. 4, the obtaining unit 32 can include a sending module 321 and a receiving module 322.

The sending module 321 is configured to send inquiry information to each of the other terminal nodes. The inquiry information sent to each other terminal node is configured to inquire the server information of the CDN server connected to the other terminal node.

The receiving module 322 is configured to receive the server information returned by each of the other terminal nodes.

Further, as shown in FIG. 4, the server information stored in each terminal node obtained by the obtaining unit 32 further includes a location of the CDN server which is connected to the terminal node by default and a download speed of the CDN server.

The recording unit can include a calculation module 331 and a recording module 332.

The calculation module 331 is configured to calculate distances between a location of itself and locations of individual CDN servers.

The calculation module 331 is further configured to calculate index values of individual CDN servers according to the calculated distances and the download speeds of the CDN servers.

The recording module 332 is configured to record each piece of server information in the server list orderly according to the index values calculated by the calculation module 331.

Further, the searching unit 34 is configured to, if the CDN server which is connected to itself by default is abnormal and data cannot be downloaded from the CDN server, search the server information which meets the preset condition from the server list.

Further, the searching unit 34 is further configured to search a preset number of pieces of server information in a descending order of the index values.

Further, as shown in FIG. 4, the requesting unit can include a determination module 351 and a requesting module 352.

The determination module 351 is configured to determine a data segment which needs to be downloaded from each of at least two CDN servers when the request for downloading data is made to the at least two CDN servers.

The requesting module 352 is configured to make the request to the at least two CDN servers for downloading the data segment corresponding to each CDN server determined by the determination module 351.

Further, as shown in FIG. 4, the device can further include an updating unit 36.

The obtaining unit 32 is further configured to obtain the server information stored in each of the other terminal nodes at preset time intervals after the requesting unit 35 makes the request for downloading data to the CDN server corresponding to the found server information.

The updating unit 36 is configured to update the server list according to the server information obtained by the obtaining unit 32.

In the device for sending a CDN address provided by embodiments of the present disclosure, P2P connections are established with other terminal nodes in a network, server information stored in each of the other terminal nodes is obtained, the server information is recorded in a server list, server information which meets a preset condition is found from the server list, and a request for downloading data is made to a CDN server corresponding to the found server information which meets the preset condition. As compared with prior arts, embodiments of the present disclosure can find information of a server which is not abnormal and request to download data to the server which is not abnormal. Thus, embodiments of the present disclosure can ensure that even the download server is abnormal, data can be downloaded successfully.

It should be noted that the functions of respective units or modules in the above device for sending a CDN address according to embodiments of the present disclosure can be realized by hardware processors.

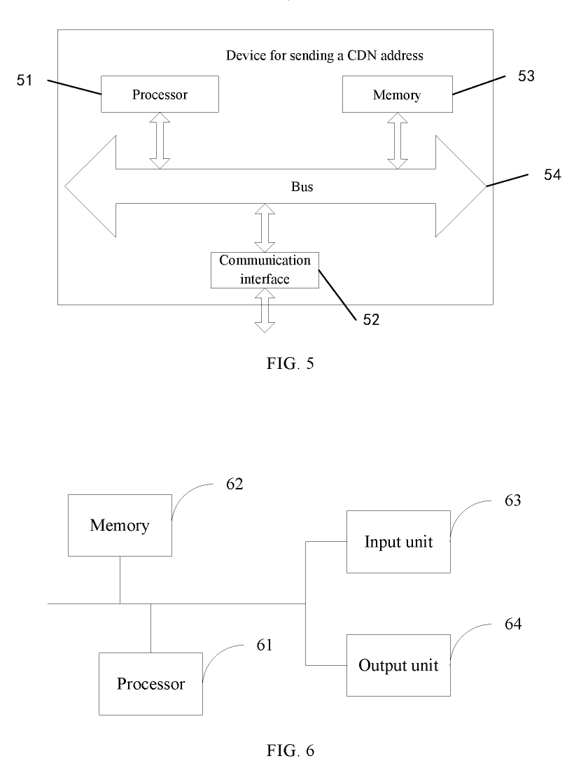

As an example, FIG. 5 is a block diagram showing a structure of a device for sending a CDN address in accordance with an embodiment of the present disclosure. The device for sending a CDN address can include a processor 51, a communication interface 52, a memory 53 and a bus 54. The processor 51, the communication interface 52 and the memory 53 communicate with each other via the bus 54. The communication interface 52 may be used for information transmission between the server and a client. The processor 51 calls logic instructions in the memory 53 to perform the following method: establishing P2P connections with other terminal nodes in a network; obtaining server information stored in each of the other terminal nodes, wherein the server information stored in each terminal node includes an (IP address of a CDN server which is connected to the terminal node by default; recording the obtained server information and server information of a CDN server which is connected to itself by default into a server list; searching server information which meets a preset condition from the server list; and making a request for downloading data to a CDN server corresponding to the found server information.

In addition, the logic instructions in the memory 53 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for sending a CDN address mentioned by embodiments of the present disclosure.

FIG. 6 is a block diagram of an electronic device which is configured to perform the methods for sending a CDN address according to an embodiment of the present disclosure. As shown in FIG. 6, the device includes:

one or more processors 61 and memory 62. A processor 61 is showed in FIG. 6 for an example.

Device which is configured to perform the methods for sending a CDN address can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for sending a CDN address mentioned by embodiments of the present disclosure (such as shown in FIG. 3, establishing unit 31, obtaining unit 32, recording unit 33, searching unit 34 and requesting unit 35). Processor 61 performs kinds of functions and sending a CDN address of the electronic device by executing non-transitory software program, instructions and modules which are stored in memory 62, thereby realizes the methods for sending a CDN address mentioned by embodiments of the present disclosure.

Memory 62 can include program storage area and data storage area, thereby the operating system and applications required by at least one function can be stored in program storage area and data created by using the device for sending a CDN address can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for sending a CDN address by networks. The examples of said networks are including but not limited to Internet, Intranet, LAN, mobile Internet and their combinations.

Input unit 63 can be used to receive inputted number, character information and key signals causing user configures and function controls of the device for sending a CDN address. Output unit 64 can include a display screen or a display device.

The said module or modules are stored in memory 62 and perform the methods for sending a CDN address when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for sending a CDN address, implemented by a terminal node, wherein the method comprises:
establishing peer-to-peer (P2P) connections with other terminal nodes in the network than the terminal node;
obtaining server information stored in each of the other terminal nodes, wherein the server information stored in each terminal node comprises an internetworking protocol (IP) address of a CDN server which is connected to the terminal node by default;
recording the obtained server information and server information of a CDN server which is connected to the terminal node itself by default into a server list;
searching server information which meets a preset condition from the server list; and
making a request for downloading data to a CDN server corresponding to the found server information.

2. The method according to claim 1, wherein the obtaining of server information stored in each of the other terminal nodes comprises:
sending inquiry information to each of the other terminal nodes, wherein the inquiry information sent to each other terminal node is configured to inquire the server information of the CDN server connected to the other terminal node; and
receiving the server information returned by each of the other terminal nodes.

3. The method according to claim 1, wherein the server information stored in each terminal node further comprises a location of the CDN server which is connected to the terminal node by default and a download speed of the CDN server; and
the recording of the obtained server information and server information of the CDN server which is connected to itself by default into the server list, comprises:
calculating distances between a location of the terminal node itself and locations of individual CDN servers;
calculating index values of individual CDN servers according to the calculated distances and the download speeds of the CDN servers; and
recording each piece of server information in the server list orderly according to the index values.

4. The method according to claim 3, wherein the searching of server information which meets the preset condition from the server list comprises:
if the CDN server which is connected to the terminal node itself by default is abnormal and data cannot be downloaded from the CDN server, searching the server information which meets the preset condition from the server list.

5. The method according to claim 4, wherein the searching of the server information which meets the preset condition from the server list comprises:
searching a preset number of pieces of server information in a descending order of the index values.

6. The method according to claim 1, wherein when the request for downloading data is made to at least two CDN servers, a data segment which needs to be downloaded from each of the CDN servers is determined, and the request is made to the at least two CDN servers for downloading the data segment corresponding to each CDN server.

7. The method according to claim 1, wherein after making the request for downloading data to the CDN server corresponding to the found server information, the method further comprises:
obtaining the server information stored in each of the other terminal nodes at preset time intervals; and
updating the server list according to the server information.

8. An electronic device, comprising:
at least one processor; and
a memory communicably connected with the at least one processor for storing instructions executable by the at least one processor, wherein execution of the instructions by the at least one processor causes the at least one processor to:
establish P2P connections with other terminal nodes in the network;
obtain server information stored in each of the other terminal nodes, wherein the server information stored in each terminal node comprises an internetworking protocol (IP) address of a CDN server which is connected to the terminal node by default;
record the obtained server information and server information of a CDN server which is connected to the electronic device itself by default into a server list;
search server information which meets a preset condition from the server list; and
make a request for downloading data to a CDN server corresponding to the found server information.

9. The electronic device according to claim 8, wherein the obtaining of server information stored in each of the other terminal nodes comprises:
sending inquiry information to each of the other terminal nodes, wherein the inquiry information sent to each other terminal node is configured to inquire the server information of the CDN server connected to the other terminal node; and
receiving the server information returned by each of the other terminal nodes.

10. The electronic device according to claim 8, wherein the server information stored in each terminal node further comprises a location of the CDN server which is connected to the terminal node by default and a download speed of the CDN server; and
the recording of the obtained server information and server information of the CDN server which is connected to the electronic device itself by default into the server list, comprises:
calculating distances between a location of the electronic device itself and locations of individual CDN servers;
calculating index values of individual CDN servers according to the calculated distances and the download speeds of the CDN servers; and
recording each piece of server information in the server list orderly according to the index values.

11. The electronic device according to claim 10, wherein the searching of server information which meets the preset condition from the server list comprises:
if the CDN server which is connected to the electronic device itself by default is abnormal and data cannot be downloaded from the CDN server, searching the server information which meets the preset condition from the server list.

12. The electronic device according to claim 11, wherein the searching of the server information which meets the preset condition from the server list comprises:
searching a preset number of pieces of server information in a descending order of the index values.

13. The electronic device according to claim 8, wherein the instructions are executed to cause the at least one processor to:
when the request for downloading data is made to at least two CDN servers, determine a data segment which needs to be downloaded from each of the CDN servers, and make the request to the at least two CDN servers for downloading the data segment corresponding to each CDN server.

14. The electronic device according to claim 8, wherein after making the request for downloading data to the CDN server corresponding to the found server information, the instructions are executed to cause the at least one processor to:
obtain the server information stored in each of the other terminal nodes at preset time intervals; and
update the server list according to the server information.

15. A non-transitory computer-readable storage medium storing executable instructions, wherein the executable instructions are configured to:
establish P2P connections with other terminal nodes in the network than a terminal node that execute the instructions;
obtain server information stored in each of the other terminal nodes, wherein the server information stored in each terminal node comprises an internetworking protocol (IP) address of a CDN server which is connected to the terminal node by default;
record the obtained server information and server information of a CDN server which is connected to the terminal node itself by default into a server list;
search server information which meets a preset condition from the server list; and
make a request for downloading data to a CDN server corresponding to the found server information.

16. The non-transitory computer-readable storage medium according to claim 15, wherein the obtaining of server information stored in each of the other terminal nodes comprises:
sending inquiry information to each of the other terminal nodes, wherein the inquiry information sent to each other terminal node is configured to inquire the server information of the CDN server connected to the other terminal node; and
receiving the server information returned by each of the other terminal nodes.

17. The non-transitory computer-readable storage medium according to claim 15, wherein the server information stored in each terminal node further comprises a location of the CDN server which is connected to the terminal node by default and a download speed of the CDN server; and
the recording of the obtained server information and server information of the CDN server which is connected to itself by default into the server list, comprises:
calculating distances between a location of the terminal node itself and locations of individual CDN servers;
calculating index values of individual CDN servers according to the calculated distances and the download speeds of the CDN servers; and
recording each piece of server information in the server list orderly according to the index values.

18. The non-transitory computer-readable storage medium according to claim 17, wherein the searching of server information which meets the preset condition from the server list comprises:
if the CDN server which is connected to the terminal node itself by default is abnormal and data cannot be downloaded from the CDN server, searching the server information which meets the preset condition from the server list.

19. The non-transitory computer-readable storage medium according to claim 15, wherein the executable instructions are further configured to:
when the request for downloading data is made to at least two CDN servers, determine a data segment which needs to be downloaded from each of the CDN servers, and make the request to the at least two CDN servers for downloading the data segment corresponding to each CDN server.

20. The non-transitory computer-readable storage medium according to claim 15, wherein after making the request for downloading data to the CDN server corresponding to the found server information, the executable instructions are further configured to:
obtain the server information stored in each of the other terminal nodes at preset time intervals; and
update the server list according to the server information.
